(19) United States
(12) Patent Application Publication
(10) Pub. No.: US 2003/0154840 A1
(43) Pub. Date: Aug. 21, 2003

(54) Disposable food delivery apparatus

(75) Inventor: John J. O'Brien, Winnemucca, NV (US)

Correspondence Address: ALAN J. HOWARTH, P.O. BOX 1909, SANDY, UT, 84091-1909, US

(73) Assignee: Trans Global Foods, Inc.

(21) Appl. No.: 10/080,283

(22) Filed: Feb. 20, 2002

(51) Int. Cl. B28D 1/04

(52) U.S. Cl. 83/835; 125/13.01; 83/855; 83/663; 125/22

(57) ABSTRACT

Cubic boron nitride tooling, e.g. for woodworking, is fabricated with the same geometries and machinery as is used for fabricating conventional carbide tooling.

### CROSS-REFERENCE TO OTHER APPLICATION

This application claims priority from No. 60/269,999 filed Feb. 20, 2001, which is hereby incorporated by reference.

### BACKGROUND AND SUMMARY OF THE INVENTION

The present invention relates to tools for cutting hard, non-metallic materials including abrasive wood and wood-based composites. More specifically, tools of interest include circular saws, milling cutters, routers, panel cutters and similar tools whose cutting edges can be fabricated from blanks of ultrahard polycrystalline cubic boron nitride (CBN) or the like.

Background: Woodworking Tools

Tooling for woodworking-type applications has some significant differences from the requirements of metalworking. (Many of the materials which are cut in woodworking-type applications are not merely wood, and sometimes not wood at all: particleboard and oriented-strand fiberboard, as well as non-wood polymers such as Melamine™ or other inorganic-loaded durable composites, may be encountered.) Common features of woodworking-type applications include air cooling (and associated high tooth speeds), workpiece materials with shear strengths much lower than ferrous metals, high shock loading (in many cases), and high abrasion. (Even among pure wood materials, many include microparticles of silicon dioxide, and composite materials may contain very abrasive filler components.)

Background: Carbide-Toothed Circular Saws

Cutting tools (especially woodworking tools) often use inserted teeth of a material which is harder than the hardest of steels. The most common material used for this is a “cemented carbide,” which typically includes small grains of tungsten carbide bonded into a matrix with a metal (typically cobalt). (Because the strength and hardness of the matrix are derived from the grains of tungsten carbide, such cemented carbides are often referred to simply as “carbide.”) Such “carbide” saw tips have a hardness of about 92 (Rockwell A).

Some firms manufacture only the steel bodies of circular saws, which are hardened, tempered and finished in every way except for tipping, and are then sold to other saw manufactures who specialize in carbide tipping. Other firms manufacture the complete saws including both the steel bodies and the installed tips. In either case, the same standard carbide tips are used in the fabrication of the blades. The steel bodies are normally made of high-carbon alloy tool steel, then a pocket is ground into the periphery of the saw body to accommodate the carbide tips. The tips may be ¼ to ⅜ inches long, 0.062 to 0.093 inches thick and from 0.10 to 0.375 inches wide, depending on the width of the finished saw blade.

In the woodworking industry, carbide tipped saws are typically 8 to 20 inches in diameter. Depending on their function, the 8 inch blades may have between 24 and 48 teeth, and the larger saws 60 to 100 teeth. For cutting non-ferrous metals, the number of teeth is typically between 24 and 80 for saws ranging from 8 to 18 inches in diameter. However, saws with greater tooth density (i.e. more teeth per inch) would be required to produce superior finishes and to cut thin materials.

Background: Ultrahard Cutting Tool Materials

Carbides were invented in the 1920s, and the search for better cutting materials continues to this day. In general, the ideal cutting tool surface should combine abrasion-resistance (hardness) with shock-resistance (toughness). (Of course there are many other relevant properties, including yield strength, rigidity, temperature limits, corrosion resistance in some applications, etc.) Materials which are harder than carbides are particularly interesting for woodworking applications, as well as many other applications.

In early 1970s, General Electric Company introduced a variety of Polycrystalline Diamond (PCD) cutting tool materials consisting of a layer of micron-sized diamonds integrally bonded with a carbide substrate. These man-made ultrahard crystalline and polycrystalline compounds have become readily available from commercial sources in a variety of grades, making possible tremendous advances in cutting tool design.

In practice, thin layers of PCD or CBN are bonded to a disk of tungsten carbide substrate ranging from 60 to 100 mm in diameter. The process requirements are extreme, e.g. 1300° C. and tens of thousands of atmospheres of pressure. These bonded disks, or wafers, generally have a combined thickness of around 3 to 4 mm with PCD or PCBN forming a single-sided layer 0.1 to 0.3 mm thick. The substrate face of tungsten carbide is ground flat and overall thickness is further reduced by grinding to one of several industry standard dimensions.

Then, using sophisticated computer controlled wire electrical discharge machine tools, the wafers are sliced into squares, rectangle, and round shapes dimensionally similar to standard carbide blanks and inserts. Ultimately, these “preforms” are ground into final dimensions for lathe tools or otherwise incorporated onto tool steel bodies in the same manner as carbide tips and inserts, and are sharpened by various special techniques.

The diamond layer's abrasion resistance, coupled with the carbide's strength, produced a cutting tool material that achieved a tremendous increase in machining performance over other available materials, tungsten carbide, for example. PCD is primarily used in non-ferrous metalworking applications such as copper and aluminum or to machine plastics, rubber, synthetics, and laminates. It had also found widespread use in sawing and shaping medium-density fiberboard and chipboard in the furniture industry. Unfortunately, notwithstanding is superb properties, it reacts chemically with iron and steel and cannot be used to machine any steel alloy.

Polycrystalline Cubic Boron Nitride (PCBN) is used for machining ferrous materials such as gray cast iron. PCBN is manufactured like PCD, except that a layer of cubic boron nitride crystals replace the diamond. Excellent machining results are obtained with PCBN-based tools in finish-turning work on nickel-based alloys. Because of its great hardness and wear resistance, PCBN cutting tools can be used at high cutting speeds and temperatures. In addition to higher available cutting speeds and excellent wear behavior, PCBN cutting materials achieve longer tool lives, allowing parts to be finished in a single cut, reliably attaining high accuracy over a long machining time.

Both PCD and PCBN provide major improvements over conventional carbide cermets, and it is now possible to machine substances that have previously been extremely difficult to fabricate. The most common ultrahard materials used in modern tools are polycrystalline diamond (PCD), which is 3.6 times harder than tungsten carbide, and cubic boron nitride (CBN), which is 2.8 times harder than carbide. However, the very properties of hardness and abrasion resistance that make polycrystalline tools superior cutting devices also make these tools extremely difficult to grind and finish.

Background: Cost Considerations for Ultrahard Materials

Despite their extraordinary performance, the application of these ultrahard materials is frequently limited by their high cost, which is at least ten times that of tungsten carbide. In addition, because of their extreme hardness, they can only be shaped with varying degrees of difficulty. PCD can only be ground by special diamond grinding wheels that are no harder than the PCD, and therefore, have a short service life. Other means of shaping PCD include electrodischarge machining (EDM) by either wire or shaped carbon electrode methods. Both of these methods require expensive, specialized computer controlled equipment that further adds to the cost of the tools in which they are incorporated.

The cost of polycrystalline diamond (PCD) and cubic boron nitride (CBN) are approximately the same. One might think, therefore, that absent diamond's inability to machine ferrous materials, there would be no practical use for PCBN which is less hard and less resistant to abrasion than PCB. Presumably because of the technical superiority of PCD over PCBN, no manufacturer recommends PCBN for wood, wood-composite products or plastics. Further, no toolmaker supplies tools for these applications.

Background: Grit-Surfaced (Non-Toothed) “Saws”

A common type of cutting tool is a circular blade which does not have shaped teeth at its edge, but which is simply coated with a diamond grit. Such cutting tools are commonly referred to as diamond “saws,” but in fact they do not perform the same type of material-removal action as is performed by a saw with shaped teeth. A saw with shaped teeth, when it is operating correctly, will carve off chips of material. By contrast, a grit-coated blade will have more of a scraping or abrasive action. (See generally Jim Effner, Chisels on a wheel (1992); and Peter Koch, Utilization of Hardwoods Growing on Southern Pine Sites (1985); both of which are hereby incorporated by reference.) A cutting action is greatly preferable for many applications, to produce a cleaner cut, lower temperature, and lower power requirements.

Polycrystalline Cubic Boron Nitride (PCBN) Woodworking Tools and Methods

The present inventors have discovered that PCBN cutting tips can be accurately ground with the same equipment commonly used to fabricate high quality tungsten carbide tools, with substantially the same geometries, and with only slight modifications of technique. Thus it turns out that, for woodworking applications, PCBN tooling is much more nearly analogous to carbide than to diamond. This is quite contrary to common belief in the industry, and radically changes the economics of PCBN tooling.

There are severe restrictions on tooth geometry of PCD tools, particularly the hook angle: the use of positive hook angles (as is usual with circular saws for woodworking) can cause PCD tools to chatter or to suffer fracture. (Hook angle is the angle of the leading face of the tooth: if the tooth is angled to pull workpiece material back toward the center of the blade, it is said to have a positive hook angle.) Thus use of very small or negative hook angles is necessary with PCD tools. The geometry of PCBN cutters however, can be made to very closely approximate those of proven carbide tools, i.e. positive hook angles can be used for faster and cooler cutting.

A profound advantage of PCBN over PCD in all but the largest operations, is that PCBN tools can be maintained using modified $20,000 grinding machines where PCD requires an electrodischarge machine costing ten times as much. This makes on-site or near site service feasible, reduces tool repair costs, turnaround time, and the inventory cost of spares.

### BRIEF DESCRIPTION OF THE DRAWING

The disclosed inventions will be described with reference to the accompanying drawings, which show important sample embodiments of the invention and which are incorporated in the specification hereof by reference, wherein:

FIG. 1 shows a circular saw blade using the novel cutting tips of the present application.

FIG. 2A shows a section of a conventional circular saw blade like that of FIG. 1, with diamond-tipped teeth set with a negative hook angle.

FIG. 2B shows a section of a circular saw blade like that of FIG. 1, with teeth having a zero negative hook angle.

FIG. 2C shows a section of the circular saw blade of FIG. 1, with cubic-boron-nitride-containing teeth set with a positive hook angle.

FIG. 3 shows an example of another cutting tool which can use teeth like those of FIG. 2C, and also shows how hook angle is measured in such tools.

### DETAILED DESCRIPTION OF THE PREFERRED EMBODIMENTS

The numerous innovative teachings of the present application will be described with particular reference to the presently preferred embodiment (by way of example, and not of limitation).

At first appearance, it would appear that PCBN could not compete with PCD in the areas amenable to PCD applications. PCD is harder than PCBN and tests on certain materials show that it is less resistant wear. However, studies and experiments by the present inventors have indicated that wear due to abrasion is most important, and that wear tests of PCBN conducted on hardened steel at 600° C. are not necessarily applicable to cutting wood products where sharpness and edge retention are paramount. At this juncture we have not proved that wear characteristics of PCBN woodworking tools are inferior to PCD at all (although this is suspected from physical properties).

It turns out that most carbide tools compete with other carbide tools and not with PCD. If PCBN tools can be produced at five times the cost of carbide tools (a realistic expectation, especially if using the novel tooth configuration of Ser. No. 09/469,673, which is hereby incorporated by reference) and PCBN outlasts carbide by 20 fold, it is quite feasible to economically use PCBN tools in wood-product applications.

It has been discovered, through experimentation and field test that rotating tools (e.g. saws, shapers, and routers) tipped with Polycrystalline Cubic Boron Nitride (PCBN) cutting elements, perform extremely well in the shaping of medium-density fiberboard and chipboard material. These tools were made in the laboratory of Sheffield Saw and Tool using readily available preforms from two of the major suppliers of PCBN.

In a sample embodiment, the cutting tips are commercial carbide-backed BZN boron nitride (from GE), supplied in widths about 0.040″ over that required. The cutting tip blanks were brazed into place using a standard low-melting-point high-Ag silver solder (Handy and Harmon Eazy-Flow-3, in a sample embodiment).

Top grinding was done with a Vollmer CHC 020 machine, and side grinding was done with a Vollmer FS2A dual side-grinder. (These are machines which are normally used for grinding carbide teeth, and are NOT suitable for grinding diamond teeth.) Triple-chip tooth geometry was used in a sample embodiment, but other geometries can be used, including alternate top bevel (ATB), conical ATB, ATB/chamfer, flat, conical-flat, and trapezoidal, for example.

Both single- and dual-grit diamond wheels have been used successfully.

In a sample embodiment, diamond grit sizes from 200 to 800 grit have been used, i.e. closely comparable to those which would be used for sharpening a carbide-toothed blade.

However, a notable difference is that the feed rate must be less for grinding boron nitride-tipped cutters than for conventional carbide-tipped ones. In a sample embodiment, the feed rate was reduced to 50% of that which would be used for grinding conventional saw tooth carbides.

The hook angles of the PCBN teeth were typically set at about 5 degrees less than would be used for a positive-hook carbide tooth application. Thus for a rough ripping application, where a carbide tooth might be set at 20° or more, a PCBN tooth would be given a hook angle of e.g. 15°. (However, PCBN teeth are believed to be less economical for such applications, due to the high density of foreign objects encountered.) The key point is the PCBN teeth can be given a hook angle which is less positive than that of carbide teeth, but significantly more positive than would be possible with diamond teeth.

Performance comparison against carbide shows that the PCBN tools outperform carbide by at least a factor of 50. An accurate performance index is difficult to compute, because the lifetimes of the PCBN tools are so extremely long.

A test was also run to compare an experimental PCBN saw with a conventional PCD saw. The operator who was using a PCD saw on a trial basis complained that the force required to push the saw through the material was excessive compared to a carbide blade. No problem was experienced with a PCBN blade, probably because the hook angle was comparable to that on a carbide blade.

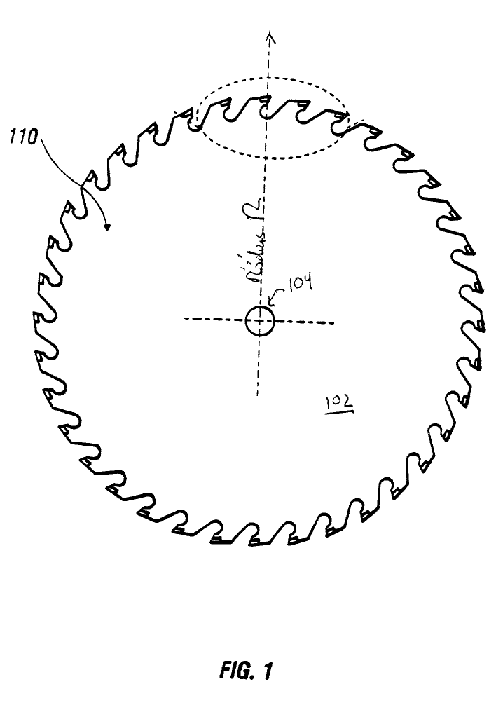

FIG. 1 shows a circular saw blade 110 using the novel cutting tips of the present application. As described above, the body 102 will typically be a steel plate, typically with appropriate tensioning for flatness under load. Radius R, reproduced in the following figures, will be used to show how the tooth geometry relates to the central hole 104.

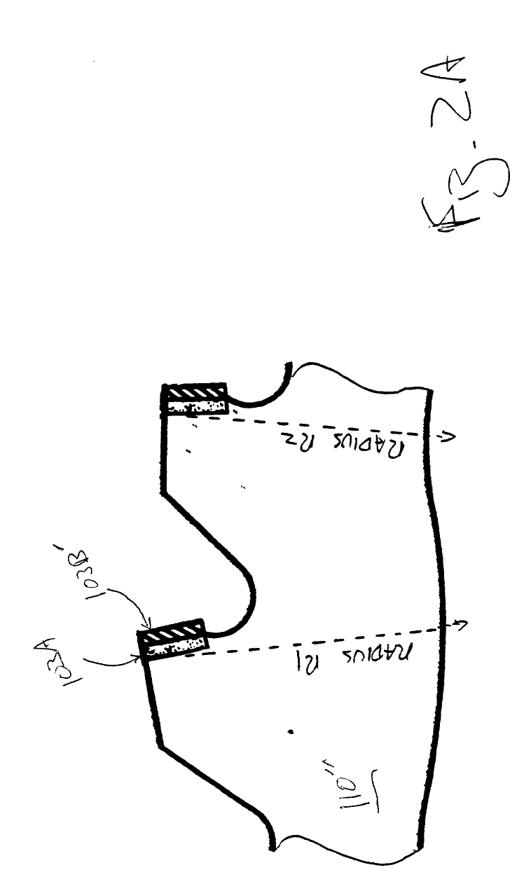

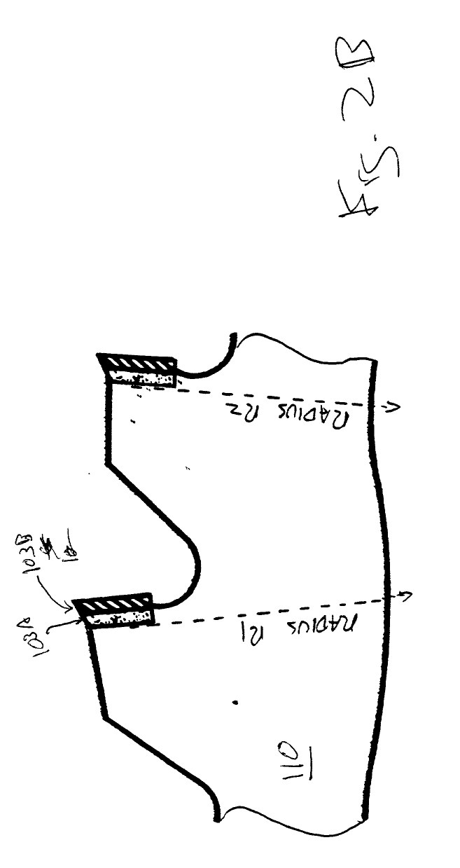

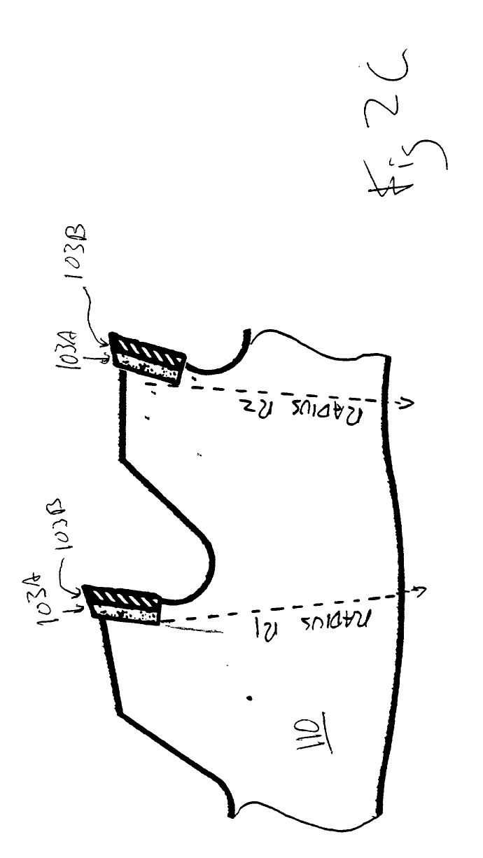

FIG. 2C shows a section of the circular saw blade of FIG. 1, with cubic-boron-nitride-containing teeth 103A/103B set with a positive hook angle. Note that the blade's radii do NOT lie in the face plane of each tooth. Preferable these teeth, as described above, include a PCBN layer 103B on a tungsten carbide layer 103A. The positive hook angle shown in this Figure has been slightly exaggerated for clarity, but is preferably more positive than would be used with diamond-coated teeth. Hook angles differ with different application, but, for any given application, the hook angle preferably used with the teeth of the presently preferred embodiment is more positive than that which would be used with diamond, and preferably is closer to the angle which would be used (for that application) with a carbide tooth rather than a diamond tooth.

FIG. 2A shows a section of a conventional circular saw blade, with diamond-tipped teeth set with a negative hook angle. In this example two instances of the radius R are shown, to show how the tooth face plane relates to the blade radius: note how each tooth is leaning slightly backwards (opposite to the geometry of FIG. 2C).

For clarity, FIG. 2B shows a section of a conventional circular saw blade 110″ in which the teeth are set with a zero negative hook angle.

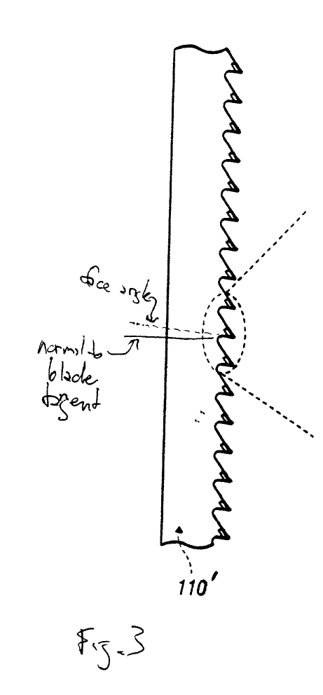

FIG. 3 shows an example of another cutting tool which can use teeth like those of FIG. 2C, and also shows how hook angle is measured in such tools. The solid line is normal (perpendicular) to the cutting tooth circle (which in this example has infinite radius, i.e. is a straight line), and the dotted line shows the face plane of a tooth. In this example the teeth are set with a slight “scooping” angle, i.e. have positive rake.

Definitions:

Following are short definitions of the usual meanings of some of the technical terms which are used in the present application. (However, those of ordinary skill will recognize whether the context requires a different meaning.) Additional definitions can be found in the standard technical dictionaries and journals.

Braze: to solder with brass or other hard alloy.

Carrier Blade: a blade, typically made of steel, to which a cutting tip is attached.

Carbide: a material more commonly referred to as cemented carbide which typically includes small grains of tungsten carbide bonded into a matrix at high temperatures and pressure by another metal which is typically cobalt. The name cemented carbide comes from the fact the both the strength and hardness of the substance are derived from the compound of tungsten and carbon (WC), and another material (frequently cobalt) serves merely as a binder.

Chatter: as used herein is vibration or movement of the cutting tool engaged in the cut due to exterior forces applied against an inadequately supported cutting tip.

Cutting Tip: a material that is usually harder than steel that is attached to the tips of a carrier blade to provide a harder cutting surface. (See FIGS. 1, 2, and 3 for an illustration).

Solder: to make a tight junction of metallic sheets, piping, and the like, by the application of a molten alloy.

Tungsten Carbide: (WC), a cemented carbide which is harder than steel.

Pocket: an indention in a carrier blade shaped to receive a cutting tip. (See FIGS. 1, 2, and 3 for an illustration).

Superhard Material: any material harder than steel.

Ultrahard Materials: any material harder than tungsten carbide, including but not limited to polycrystalline diamond (PCD) and cubic boron nitride (CBN).

Modifications and Variations

As will be recognized by those skilled in the art, the innovative concepts described in the present application can be modified and varied over a tremendous range of applications, and accordingly the scope of patented subject matter is not limited by any of the specific exemplary teachings given.

For example, the described methods and geometries are not solely applicable to woodworking-type applications, but can also be applied advantageously to other applications where abrasion resistance is a high concern (such as precision machining of uncured or partially-cured ceramic structures).

It should also be noted that the disclosed inventions are applicable to manual-feed as well as to automatic grinding machines.

Note also that, although woodworking applications are preferred, boron nitride teeth can also cut ferrous materials (unlike diamond teeth).

None of the description in the present application should be read as implying that any particular element, step, or function is an essential element which must be included in the claim scope: THE SCOPE OF PATENTED SUBJECT MATTER IS DEFINED ONLY BY THE ALLOWED CLAIMS. Moreover, none of these claims are intended to invoke paragraph six of 35 USC section 112 unless the exact words “means for” are followed by a participle.

What is claimed is:

1. A cutting tool for woodworking-type applications, comprising:
a carrier body; and
one or more cutting tips comprising cubic boron nitride, and being attached to said carrier body;
wherein said cutting tips, as attached to said carrier body, define positive respective hook angles of 5 degrees or greater.

2. The tool of claim 1, wherein each said cutting tip is a layered combination of cubic boron nitride and tungsten carbide.

3. The tool of claim 1, wherein said cutting tips, as attached to said carrier body, define positive respective hook angles which are greater than would be possible for a diamond tooth for a given application.

4. The tool of claim 1, wherein said carrier body is steel.

5. The tool of claim 1, wherein said carrier body is a circular saw blade, and at least ten of said cutting tips are attached thereto.

6. The tool of claim 1, wherein said carrier body and said cutting tips jointly define a circular saw blade.

7. The tool of claim 1, wherein said carrier body and said cutting tips jointly define a cutter for a woodworking shaper.

8. The tool of claim 1, wherein said carrier body and said cutting tips jointly define a router bit.

9. The tool of claim 1, wherein said carrier body and said cutting tips jointly define a milling cutter.

10. A method of fabricating a woodworking tool, comprising the actions of:
attaching one or more cutting tips, comprising cubic boron nitride, to a carrier body; and
grinding said cutting tips using machinery, geometries and tooling suitable for grinding tungsten carbide cutting tips, but with a slower feed rate.

11. A woodworking tool fabricated by the method of claim 10.
